(19) United States
(12) Patent Application Publication
(10) Pub. No.: US 2015/0210511 A1
(43) Pub. Date: Jul. 30, 2015

(54) ELEVATOR INSTALLATION DEFLECTING ROLLER

(71) Applicant: Inventio AG, Hergiswil (CH)

(72) Inventor: Volker Zapf, Obernau (CH)

(21) Appl. No.: 14/414,172

(22) PCT Filed: Jul. 16, 2013
(86) PCT No.: PCT/EP2013/064960

§ 371 Date: Jan. 12, 2015

(30) Foreign Application Priority Data
Jul. 20, 2012 (EP) 12177302.2

(51) Int. Cl. B66B 15/04; F16C 23/08

(52) U.S. Cl. CPC B66B 15/04; F16C 23/088

(57) ABSTRACT

In an elevator installation a belt-like support is guided over a drive and over at least one deflecting roller. The deflecting roller includes an inner ring and an outer ring with a traction surface. The belt-like support loads the deflecting roller in a direction of loading, wherein the direction of loading is oriented substantially perpendicularly to an axis of the deflecting roller. The outer ring is mounted on the inner ring to be movable in axial direction so that in the case of a change in the direction of loading by an angle α the outer ring similarly inclines substantially through the angle α, whereby a perpendicular orientation of the direction of the loading with respect to the traction surface is substantially maintained.

### FIELD

The present invention relates to an elevator installation and, in particular, to a design of a deflecting roller in this elevator installation.

### BACKGROUND

Steel cables are conventionally used in elevator installations as support means for supporting and/or driving an elevator car. According to a development of such steel cables use is also made of belt-like support means comprising tensile carriers and a casing arranged around the tensile carriers. Such belt-like support means are, similarly to conventional steel cables, guided over drive pulleys and deflecting rollers in the elevator installation. By contrast to steel cables, however, belt-like support means are not guided in grooves in the deflecting rollers or drive pulleys, but the belt-like support means lie substantially on the deflecting rollers or drive pulleys.

Support means do not always run in elevator installations exactly perpendicularly to an axis of deflecting rollers or drive pulleys. Diagonal tension can occur on the one hand due to a construction or on the other hand be caused by imprecise mounting of the elevator installation. Due to such diagonal tension of the support means there is the risk that the support means slips laterally off a deflecting roller or a drive pulley of the drive. In order to avoid this it is sought to guide the belt-like support means laterally on deflecting rollers or drive pulleys. Thus, for example, use is made of crowned deflecting rollers on which support means of that kind are to a certain extent guided laterally. In order to prevent lateral slipping-off of the belt-like support means use is also made of raised side edges at the deflecting rollers or drive pulleys. In addition, belt-like support means with longitudinal ribs and longitudinal grooves on the traction surface of the support means as well as on the traction surface of the deflecting rollers or drive pulleys are also known, which interengage and thus ensure lateral guidance of the belt-like support means on the deflecting rollers or drive pulleys.

However, it has proved that measures such as crowned deflecting rollers and drive pulleys, raised lateral edges or longitudinal grooves in the support means cannot prevent lateral slipping-off of the support means in every circumstance. Particularly in the case of support means with longitudinal grooves it was observed that the support means due to diagonal tension was laterally displaced by one or more longitudinal ribs so that the support means protruded laterally beyond the deflecting roller without completely slipping off laterally. There is thus the risk that a support means at least partly slips off a deflecting roller or a drive pulley laterally without this being recognized at the safety systems of the elevator installation.

### SUMMARY

It is therefore an object of the present invention to provide an elevator installation in which there is reliable prevention of at least partial lateral slipping-off from deflecting rollers. Such equipment shall in addition be economic in production and robust in use.

This object is fulfilled by an elevator installation in which a belt-like support means is guided over a drive and over at least one deflecting roller, wherein the deflecting roller comprises an inner ring and an outer ring with a traction surface and wherein the belt-like support means loads the deflecting roller in a direction of loading. The direction of loading is oriented substantially perpendicularly to a bearing axis of the deflecting roller. The outer ring is mounted on the inner ring to be movable in axial direction so that in the case of a change in the direction of loading by an angle α the outer ring similarly tips substantially through the angle α. A perpendicular orientation of the direction of loading with respect to the traction surface is thereby substantially maintained.

The provision of a deflecting roller with an inner ring and an outer ring movable in axial direction with respect thereto has the advantage that compensation for possible diagonal tension of the belt-like support means is provided by the pulley itself. The direction of loading is thus always oriented substantially perpendicularly to the traction surface of the deflecting roller. An at least partial lateral slipping of the belt-like support means off the deflecting roller is thereby effectively prevented, since the belt-like support means is always oriented substantially perpendicularly to the traction surface of the deflecting roller. Such deflecting rollers additionally have the advantage that no further adaptations in the elevator installation are needed. Such deflecting rollers can thus be directly used instead of conventional deflecting rollers without further adaptations in the elevator installation being required.

Such deflecting rollers are thus suitable for replacing conventional deflecting rollers in already existing elevator installations.

Such deflecting rollers additionally have the advantage that a certain amount of diagonal tension, which is attributable to the system, in the elevator installation is tolerable. Through the automatic neutralization of possible diagonal tension by the deflecting rollers a certain amount of diagonal tension, whether due to construction or caused by imprecise mounting, can be tolerated. It is thereby possible to save outlays on complete avoidance of diagonal tension not only in the design of the elevator installation, but also in the mounting of the elevator installation.

The deflecting roller can be constructed as, for example, a slide bearing or a rolling bearing. In a first embodiment the deflecting roller is constructed as a rolling bearing, wherein rollable bodies are arranged between the inner ring and the outer ring. Rollers or barrels or balls come into question as rollable bodies. Accordingly, in one embodiment the deflecting roller is constructed as a self-aligning roller bearing or as a self-aligning ball bearing.

In an alternative embodiment the deflecting roller is constructed as a slide bearing. In that case, the inner ring and the outer ring are so constructed that the outer ring is mounted on the inner ring to be movable in axial direction.

In an advantageous form of embodiment the outer ring is tiltable about a center point of the deflecting roller. This has the advantage that the deflecting roller can be mounted on a conventional deflecting roller axle, since the inner ring does not have to have any freedom of movement relative to the deflecting roller axle.

In an exemplifying form of embodiment the belt-like support means has a substantially planar traction surface and the traction surface of the deflecting roller is formed to be substantially crowned. The belt-like support means is centered by the crowned deflecting roller and thereby prevented from lateral displacement on the deflecting roller, This has the advantage that the inclination of the outer ring in adaptation to diagonal tension is improved.

In an exemplifying form of embodiment the belt-like support means has a traction surface which is formed to be complementary to the traction surface of the deflecting roller. Here, too, there is the advantage that by virtue of a complementary construction a lateral guidance of the belt-like support means on the deflecting roller is achieved, which improves adaptation of the deflecting roller to a diagonal tension.

In an exemplifying form of embodiment the traction surface of the deflecting roller has at least one groove in circumferential direction and the belt-like support means has at least one longitudinal rib on the traction surface. In that case, the longitudinal rib engages in the longitudinal groove when the belt-like support means and the deflecting roller co-operate.

In an exemplifying form of embodiment the belt-like support means has six longitudinal ribs arranged parallel to one another and the deflecting roller has six longitudinal grooves, which are arranged in parallel adjacent to one another, in circumferential direction. This has the advantage that lateral guidance of the belt-like support means on the deflecting roller is achieved, which improves adaptation of the deflecting roller to diagonal tension.

In an exemplifying form of embodiment the deflecting roller is arranged at a counterweight.

In an alternative form of embodiment the deflecting roller is arranged at the car. In that case, for example, two deflecting rollers can be arranged at a car underside, wherein the belt-like support means is guided through under the car.

Such deflecting rollers can in principle be used at different locations of an elevator installation and in different types of elevator installations. Thus, such deflecting rollers can be used in elevator installations with a counterweight and in elevator installations without a counterweight. The deflecting rollers can be arranged at a counterweight or a car or, however, also in a shaft. Advantageously, such deflecting rollers are arranged at locations at which diagonal tension can probably occur.

### DESCRIPTION OF THE DRAWINGS

The invention is explained in more detail symbolically and by way of example on the basis of figures, in which:

FIG. 1 shows a schematic illustration of an exemplifying elevator installation; and

FIG. 2 shows a schematic illustration of an exemplifying deflecting roller.

### DETAILED DESCRIPTION

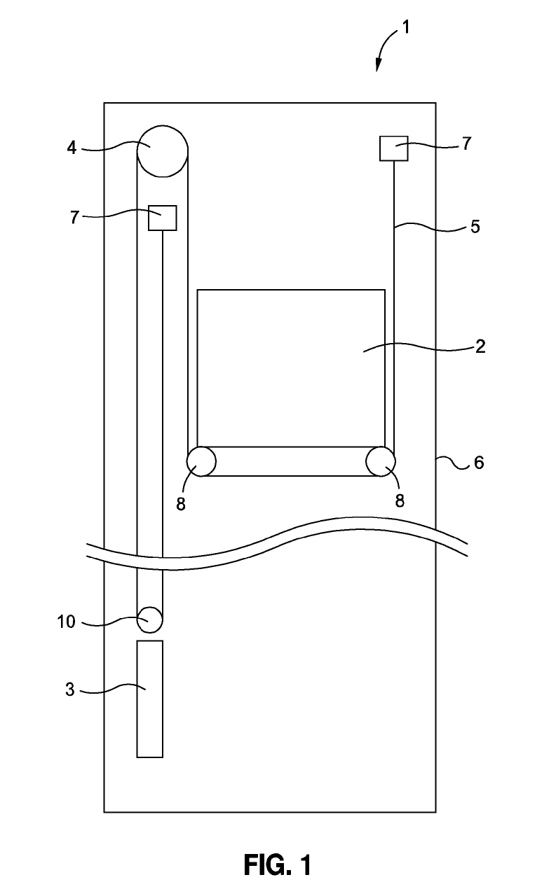

An exemplifying form of embodiment of an elevator installation 1 is illustrated in FIG. 1. The elevator installation 1 comprises a car 2, a counterweight 3, a drive 4 and a belt-like support means 5. In that case, the belt-like support means 5 is fixed in the elevator installation 1 by a first support means fastening 7, guided over a counterweight deflecting roller 10, guided over a drive pulley of the drive 4, guided over two car deflecting rollers 8 and fastened again in the elevator installation 1 by a second support means fastening 7.

In this form of embodiment the elevator installation 1 is arranged in a shaft 6. In an alternative form of embodiment (not illustrated) the elevator installation is arranged not in a shaft, but, for example, at an outer wall of a building.

The exemplifying elevator installation 1 in FIG. 1 comprises a counterweight 3. In an alternative form of embodiment (not illustrated) the elevator installation does not include a counterweight. Moreover, numerous other forms of embodiment of an elevator installation are possible.

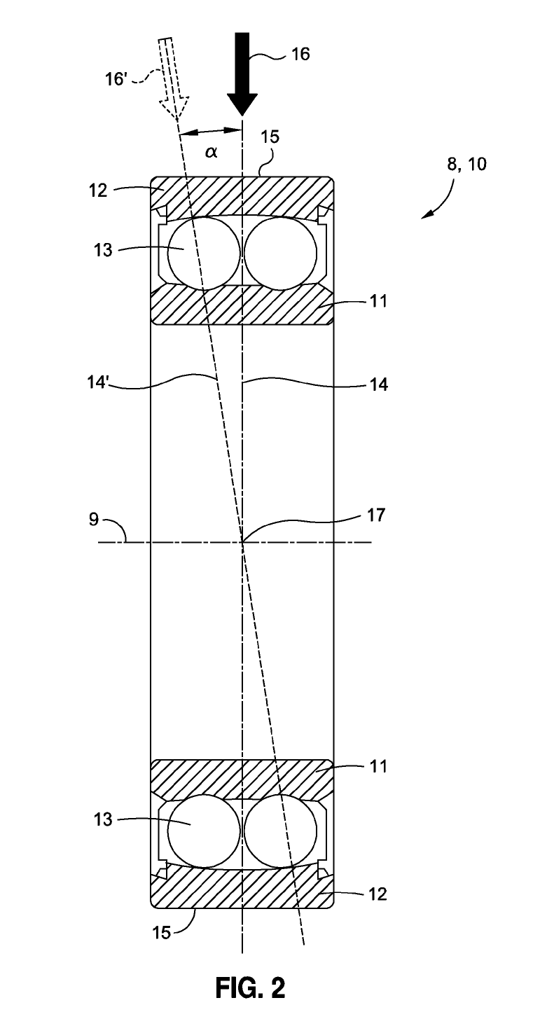

An exemplifying form of embodiment of a deflecting roller 8, 10 is illustrated in FIG. 2. The deflecting roller comprises an inner ring 11 and an outer ring 12. Rollable bodies 13 are arranged between the inner ring 11 and the outer ring 12. The surfaces of the inner ring 11 and the outer ring 12 facing the rollable bodies 13 are in that case constructed in such a manner that the outer ring 12 is mounted on the inner ring 11 to be movable in axial direction. The rollable bodies 13 are in that case guided by the inner ring 11 in such a manner that displacement of the rollable bodies 13 in axial direction relative to the inner ring 11 is not possible. However, the rollable bodies are not uniformly guided by the outer ring 12, so that displacement of the outer ring 12 relative to the rollable bodies 13 in axial direction is possible to a certain extent.

A state of the deflecting roller 8, 10 without diagonal tension is illustrated in FIG. 2. A direction 16 of loading is thus perpendicular to an axis 9 of the deflecting roller 8, 10. A pressure line 14 thus similarly extends in the direction of the direction 16 of loading and thus perpendicularly to the axis 9. In the case of diagonal tension the direction 16 of loading inclines through a pressure angle α so that the direction 16′ of loading no longer extends perpendicularly to the axis 9. Thus, the line 14′ of pressure under diagonal tension also no longer extends perpendicularly to the axis 9 under diagonal tension. Through such a displacement of direction 16, 16′ of loading through the angle α the outer ring 12 similarly inclines substantially through the angle α so that a perpendicular orientation of the direction 16, 16′ of loading with respect to a traction surface 15 is substantially maintained. Such an inclination of the outer ring 12 is not illustrated in FIG. 2.

In the case of the exemplifying deflecting roller 8, 10 illustrated in FIG. 2 a double-row self-aligning ball bearing is used. However, other bearings, which allow inclination of the outer ring, particularly self-aligning roller bearings or also slide bearings, are also conceivable.

Since not only the inner ring 11, but also the outer ring 12 are arranged concentrically with respect to a center point 17, the outer ring 12 is tiltable about the center point 17 of the deflecting roller 8, 10.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator installation including a support belt guided over a drive and over at least one deflecting roller, the at least one deflecting roller comprising:
an inner ring; and
an outer ring mounted on the inner ring and having a traction surface engaging the support belt, wherein the support belt loads the deflecting roller in a direction of loading oriented substantially perpendicularly to an axis of rotation of the deflecting roller, the outer ring being mounted on the inner ring for movement in a direction of the axis of rotation whereby when the direction of loading changes by an angle the outer ring similarly inclines substantially by the angle to substantially maintain a perpendicular orientation of the changed direction of loading with respect to the traction surface.

15. The elevator installation according to claim 14 wherein the deflecting roller is constructed as a rolling bearing, wherein rollable bodies are arranged between the inner ring and the outer ring.

16. The elevator installation according to claim 14 wherein the deflecting roller is constructed as a self-aligning roller bearing.

17. The elevator installation according to claim 14 wherein the deflecting roller is constructed as a self-aligning ball bearing.

18. The elevator installation according to claim 14 wherein the deflecting roller is constructed as a slide bearing.

19. The elevator installation according to claim 14 wherein the outer ring is inclinable about a center point of the deflecting roller.

20. The elevator installation according to claim 14 wherein the support belt has a substantially planar traction surface and wherein the traction surface of the deflecting roller is crowned so that the support belt is laterally guided on the deflecting roller.

21. The elevator installation according to claim 14 wherein the support belt has a traction surface formed to be complementary to the traction surface of the deflecting roller.

22. The elevator installation according to claim 21 wherein the traction surface of the deflecting roller has at least one groove in a circumferential direction and wherein the support belt has at least one longitudinal rib on the traction surface, wherein the longitudinal rib engages in the longitudinal groove when the support belt and the deflecting roller co-operate,

23. The elevator installation according to claim 22 wherein the support belt has six longitudinal ribs and wherein the deflecting roller has six longitudinal grooves in the circumferential direction.

24. The elevator installation according to claim 14 wherein the deflecting roller is arranged at a counterweight of the elevator installation.

25. The elevator installation according to claim 14 wherein the deflecting roller is arranged at a car of the elevator installation.

26. The elevator installation according to claim 14 wherein two of the deflecting roller are arranged at an underside of a car of the elevator installation and wherein the support belt is guided through the deflecting rollers under the car.
